(19) United States
(12) Patent Application Publication
(10) Pub. No.: US 2013/0046616 A1
(43) Pub. Date: Feb. 21, 2013

(54) SYSTEMS, METHODS, AND COMPUTER-READABLE MEDIA FOR THE TRIGGERING OF LOCATION-AWARE CONTENT VIA PRINT-BASED INPUT CONTROLS

(71) Applicants: Dale Williams, Kingston, PA (US); Jim Cioban, New Milford, CT (US); Kevin McVea, Middletown, NJ (US)

(72) Inventors: Dale Williams, Kingston, PA (US); Jim Cioban, New Milford, CT (US); Kevin McVea, Middletown, NJ (US)

(21) Appl. No.: 13/588,888

(22) Filed: Aug. 17, 2012

Related U.S. Application Data
(60) Provisional application No. 61/525,637, filed on Aug. 19, 2011.

(51) Int. Cl. G06Q 30/02

(52) U.S. Cl. 705/14.45; 705/14.67; 705/14.58; 705/14.57; 705/14.64

(57) ABSTRACT

Methods, systems, apparatuses, and computer-readable media are provided for high-volume production of personalized print pages to be included with fixed print content associated with a print publication. The personalized print page content is personalized for a specific reader, and includes a reader-specific visual element, such as a machine-readable code, that allows the reader to access electronic content pertaining to the personalized print content. The electronic content presented may include content that is personalized or customized for the reader such as content based upon the location of a computing device employed to access the content. Information associated with the readers' access of the electronic content may be tracked to allow further customization or personalization of print and/or electronic content for the reader.

### CROSS-REFERENCE TO RELATED APPLICATIONS

The present application claims benefit to U.S. Provisional Patent Application No. 61/525,637, which was filed on Aug. 19, 2011, the contents of which are incorporated by reference in their entirety as if recited in full herein.

### FIELD OF THE INVENTION

The present invention relates generally to generating print media content for readers. More particularly, the present invention pertains to systems and methods for personalizing print media content for distribution to an individual reader that includes an interactive element to allow the reader to access electronic media content through the Internet.

### BACKGROUND

Variable data printing can allow a publisher to produce a publication that includes one or more custom elements, along with fixed content (e.g., general or versioned, non-personalized content). For example, digital printing presses can be used to create large quantities of a publication that includes content for a general audience as well as custom content for a particular demographic group. Variable data printing systems may encode pages with codes such as to define the appropriate addressee or confirm the accuracy of an insertion point for the page. For example, U.S. Pat. No. 7,874,550 to Warmus discloses an apparatus and method for binding personalized content with non-personalized content in a publication via the use of indicia, such as barcodes, that enable a binding controller to determine which content is to be included in a particular copy of a publication.

Like with the publishers, various other parties often desire the ability to customize print content for certain individuals of groups of individuals. For example, advertisers continually seek improved ways to personalize (i.e., “target”) their advertisements to each specific consumer as much as possible, while doing so via affordable means. Traditional print ads, such as those in subscriber-based publications, typically offer a low cost per impression alternative to Internet advertising. However, personalized print ads created through variable data printing methods have not gained traction in the advertising industry due to several obstacles. One such obstacle is that variable data printing is typically much slower than traditional printing and, as such, can prohibit a publisher from producing the necessary quantities in the required timeframe. Additionally, the cost of variable data printing is typically too high when compared to the corresponding generated revenue.

Conversely, Internet-based technologies readily permit the delivery of highly personalized content to groups or particular individuals via websites, mobile applications, e-mail, social network applications, and other similar mediums. These methodologies allow for cost-effective targeted advertising, and many advertisers have shifted their funds away from print-based media to these electronic formats. Unlike traditional print advertisements, Internet advertising can include interactive electronic elements (e.g., links, forms, games, rich media, etc.) to encourage greater consumer participation with the advertisement. Furthermore, because many Internet-enabled devices, such as smartphones, provide location-aware features and functionality, the electronic content presented to users can be customized per their current locations. Location-aware advertising content is often appealing to advertisers as it offers a way to target adverting to consumers at a further, more specific level.

In addition, while both print content and electronic content may be customized or personalized to some degree for the readers or other individual, there was not any way for a publisher or an advertiser to combine the advantages of personalized print content with those of electronic content. For example, there is currently no mechanism that allows an individual to access user-relevant electronic content, such as personalized or location-aware content, via a printed publication.

Therefore, there is a need for a system that produces, via variable data printing, personalized print content, including print advertising, that is specific to a particular reader.

There is also a need for such a system that can produce large quantities of personalized print content in a cost-effective, time efficient manner to enable the use of such content in high-volume, frequently distributed publications such as magazines.

There is further a need for such a system that enhances personalized print content by allowing an individual to readily access user relevant electronic content from a printed page that is personalized for the individual.

Furthermore, there is still further a need for such a system that enhances personalized print content by incorporating a mechanism to allow an individual to readily access location-aware electronic content.

### SUMMARY

Methods, systems, apparatuses, and computer-readable media are provided that enable high-volume production of personalized print content (e.g., advertisement pages or creatives) to be combined with fixed print content associated with a print publication such as a periodical for distribution to readers (e.g., subscribers to the periodical). The personalized print content (which may be in the form of one or more pages that are presented as an insert or outsert to the publication) may be personalized for a specific reader, and may include a reader-specific visual element or code that can trigger the retrieval of additional electronic content such as Internet content that may be accessed by the reader. The electronic content presented may include content that is personalized or customized for the reader. Information associated with the readers' access of the electronic content may be tracked to allow further customization or personalization of print and/or electronic content for the reader.

Thus, in certain embodiments, a reader may access electronic content via a visual element, such as a machine-readable code (e.g., quick-response (QR) code), included in the personalized print content that is part of the print publication (e.g., a periodical to which the reader subscribes). The electronic content presented may include content that is relevant to the location of the reader based upon the location of a computing device employed to access the content or based upon stored reader data, such as a mailing address.

In certain embodiments, consumer data (which may be associated with one or more advertisers' targets) and reader (or subscriber) data may be merged or combined in order to create a project database. Variable content (or a portion thereof) associated with the advertiser(s)' campaign intended for the consumer or reader may be selected based on the project database, the variable content being preferably included with (e.g., as part of) a print publication. An Internet content code specific to the reader may be generated, wherein the Internet content code allows access to Internet content, which may or may not be customized for the reader, through an Internet-enabled device (e.g., a smart phone) capable of processing the code. Personalized content data specific to the reader may be generated, wherein the personalized content data may include the selected variable content data and the generated Internet content code. The personalized content data may be provided to a variable printing device for printing a reader-specific variable portion based on the personalized content data that is combined with a fixed portion of the print publication to be delivered to the user.

Other benefits and features of the present invention may become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

Further features of the invention, its nature and various advantages will be more apparent from the following detailed description of the embodiments, taken in conjunction with the accompanying drawings in which:

FIG. 1 depicts a component architecture of a personalized print content system including a customization platform according to an exemplary embodiment;

FIG. 2 depicts a flowchart of a process for creating print content that is personalized for a specific reader through a customization platform according to an exemplary embodiment;

FIG. 3 depicts an illustrative overview of a manner in which reader data and consumer data may be combined into project data by a customization platform according to an exemplary embodiment;

FIG. 4 depicts an illustrative overview of a manner in which one or more project parameters may be employed to determine variable content data elements to be included in personalized print content according to an exemplary embodiment;

FIG. 5 depicts an illustrative example of a printed page having content personalized for a specific reader that may be created via a customization platform according to an exemplary embodiment;

FIG. 6 depicts an illustrative overview of a manner in which separator sheets may be created and/or utilized by a customization platform during a variable data printing process according to an exemplary embodiment;

FIG. 7 depicts a flowchart of a process for delivering Internet content to an Internet-enabled device based upon an Internet content code included in a personalized print page created via a customization platform according to an exemplary embodiment;

FIG. 8 depicts an illustrative overview of two personalized print pages created via a customization platform both of which include an Internet content code that is specific to an individual reader according to an exemplary embodiment; and

FIG. 9 depicts an illustrative overview of gathering analytical data based upon a reader's interactions with Internet content accessed via an Internet content code included in a personalized print page created via a customization platform according to an exemplary embodiment.

### DETAILED DESCRIPTION OF EMBODIMENTS OF THE INVENTION

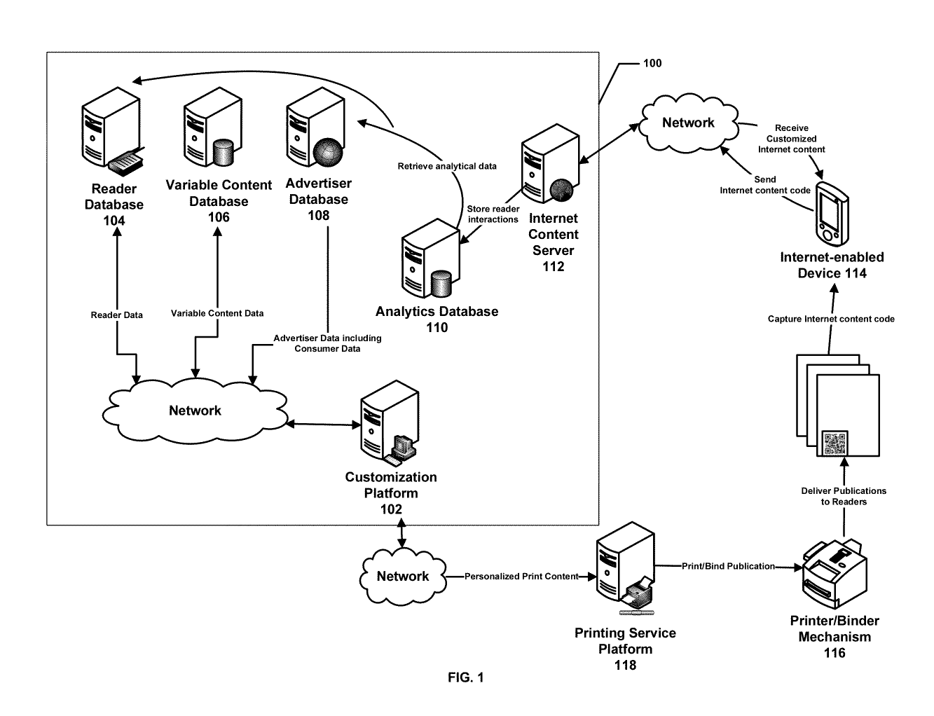

Further details are described below in relation to FIGS. 1-9, whereby FIG. 1 depicts a personalized print content system (PPCS) 100 which includes customization platform 102. FIGS. 1-9 illustrate different examples of embodiments of PPCS 100. Those skilled in the art will recognize, based on this disclosure and an understanding therefrom of the teachings hereof, that the particular hardware and devices that are part of PPCS 100, and the general functionality provided by and incorporated therein, may vary in different embodiments of the invention. Accordingly, the particular system components shown in FIGS. 1-9 are for illustrative purposes to facilitate a full and complete understanding and appreciation of the various aspects and functionality of particular embodiments of the invention as realized in method and apparatus embodiments thereof.

### Personalized Print Content System

FIG. 1 depicts a component architecture of PPCS 100 including customization platform 102 according to an exemplary embodiment. It is to be understood that the components depicted may be logical components and that the terminology used herein to describe each component is for illustrative purposes and is not to be construed as limiting. Each component may include the necessary apparatuses, hardware, firmware, and/or software to enable the processing, storing, communicating and/or receiving of data. A component may include one or more computer processors, computer servers, data stores, electronic components, storage mediums, memory, etc. The functionality of a component may be directed by one or more executable computer-readable instructions received via a computer-readable storage medium. A processor may be included to execute one or more functions per instructions, programs, or processes stored in the processor itself and/or stored in another memory source. Memory may be any mechanism that is capable of storing data, such as computer programs, instructions, and other necessary data. One or more interfaces may be included to enable the presentation, manipulation, transmission, and receipt of data. Communication of data may be enabled by one or more networks or physical connections. A network may include one or more of a wide-area network (WAN) (such as the Internet), a local area network (LAN), a wireless local area network (WLAN), a mobile wireless network a combination of any of the foregoing, or any other suitable network and may include any component (physical or logical) necessary for a particular network's functionality, such as routers, adapters, subnets, etc.

Customization platform 102 may be a print content customization system configured to analyze reader data, advertiser data (including consumer data), and variable content data in order to create and/or assemble print content that is personalized for a particular reader of a print publication. Personalized print content may include data that is customized to be relevant to a reader of a publication. A personalized print page may be a published form of personalized print content. Customization platform 102 may combine elements of reader data and elements of advertiser data, such as consumer data, to create project data for a customization project. In an exemplary embodiment, customization platform 102 may maintain the project data in a project database. Customization platform 102 may use the project data to generate personalized print content per one or more parameters set for the customization project. The parameters may indicate, for example, which variable content data is to be included and in what fashion, which demographics are to be targeted, the layout of the printed page, sequencing information, etc. A customization parameter may be established by a customization service provider, a publisher, an advertiser, and/or a printing service provider. In certain of these embodiments, a publisher and a printing service provider may be the same entity.

Customization platform 102 may encode personalized print content with one or more machine-readable codes to be included in a personalized print page. Additionally, or alternatively, personalized print content may be encoded with a code that is to be included as a human-readable code to be included in a personalized print page. As described in detail below, these codes may be used in a number of ways, such as to identify a reader, instruct printing systems and/or operators how to format a personalized print page and/or how to include it in a print publication, facilitate the detection of errors during the printing and/or binding of a print publication, enable a reader to access Internet content, etc.

PPCS 100 may include one or more database servers that maintain data for the personalization and distribution of print content, the personalization and distribution of personalized electronic content, the analysis of reader interactions with electronic content, and other functionalities. In one embodiment, PPCS 100 may include reader database 104, variable content database 106, advertiser database 108, and analytics database 110, as illustrated in FIG. 1. Furthermore, PPCS 100 may include a project database for storing project data accessed by customization platform 102 and an Internet content database for storing electronic content accessed by Internet content server 112. Although multiple databases and database servers are described, this is not to be construed as limiting and it should be understood that one or more of the databases and/or database servers may be removed, combined or separated, and other data bases may be added, depending upon implementation. Likewise, the data associated with one or more of the database servers may be maintained in other types of data structures, such as lists, log files, folders, or any other format suitable for maintaining and providing access to the data.

One or more of the databases may be maintained by the customization service provider, an advertiser, a publisher, a printing service provider, or any other suitable party such as a third-party cloud service provider. In certain of these embodiments, reader database 104, variable content database 106, and advertiser database 108 may be hosted and maintained by the same entity. In certain other embodiments, one or more of the databases may be hosted and maintained by another party. For example, advertiser database 108 may be maintained and managed by an advertising organization.

The customization service provider may receive reader data and advertiser data from a publisher and advertiser, respectively. If data requires updating, the customization service provider may obtain the updated data from the appropriate party. For example, a publisher or an advertiser may provide such data via a batch update, synchronization, update file, etc. In another embodiment, a publisher and/or an advertiser may enable the customization service provider to access one or more of its databases, or a subset thereof, in order to obtain the necessary information. Data may be updated manually or automatically by a publisher or advertiser, for example, when it updates its internal records.

Reader database 104 may include various data associated with one or more specific readers. In certain embodiments, a reader may be any individual who desires or is intended to view particular print materials, including publications such as periodicals to which the reader subscribes. A reader may be a subscriber to a print periodical or any other individual who reads the print periodical. In other embodiments, a reader may be the recipient of another form of print publication. A print publication may be a periodical, a book, a pamphlet, an insert, an outsert, a posting, a bulletin, a flyer, or any other form of printed content that is distributed to or made accessible to one or more readers. Reader database 104 may include data from one or more sources, such as data from a publisher, an advertiser, a third-party, etc. and/or may include data specific to one or more particular customization projects. For example, reader database 104 may be created and/or updated for each project in order to reflect variations in source data files received from different publishers, as well as variations in the data available for use in different publications from the same publisher. Alternatively, reader database 104 may include general reader data that may not inherently be associated with a particular project.

Reader data may include reader data records that include information regarding a reader's unique identifier (e.g., a subscription number, an identification code, etc.), mailing address, phone number, email address, demographic data, etc. Demographic data may include, for example, information regarding a reader's age, ethnicity, income level, personal interests (e.g., hobbies or favorite sport teams), job data (e.g., profession type or industry type), etc. In one exemplary embodiment, a reader data record may include a device identifier associated with an Internet-enabled device that is used by a reader (e.g., Internet-enabled device 114). A device identifier may be, for example, a phone number, a mobile device identification number (e.g., an electronic serial number (ESN), a mobile identification number (MIN), a subscriber identity module (SIM) card number, etc.), an IP address, or other information that identifies a particular Internet-enabled device.

In certain embodiments, variable content database 106 may include variable content data associated with one or more customization projects for inclusion into personalized print content. Variable content data may be provided by an advertiser, a publisher, a printing service provider, any other suitable third party content provider or any combination thereof. Variable content data may include content related to specific demographic values to be targeted. For example, variable data content may include verbal messages and images associated with an advertising campaign. As another example variable content data may include images, text, and other data associated with the substantive content (e.g., articles, stores, etc.) of the publication. These variable data elements may be indexed and cataloged for use in publications, such as by being associated with various demographic categories and/or locational information. For example, variable content data may be associated with particular locations (e.g., streets, cities, zip codes, regional data, geographic data, etc.), age groups, income levels, interest categories, job categories, etc.

In certain embodiments, advertiser database 108 may include advertising data regarding one or more consumers and/or data regarding one or more advertising campaigns. In certain of these embodiments, an advertiser may be any party wishing to advertise goods or services to one or more individuals or entities. For example, an advertiser may be a merchant, a manufacturer, an advertising agency, a marketing firm, a non-profit organization, etc. Advertising data may include consumer data, which may include one or more data records regarding specific individuals an advertiser wishes to target and/or has had interactions with (e.g., customers, etc.). Consumer data may include a record for each consumer that includes information regarding a consumer's name, mailing address, phone number, email address, demographics, shopping history, loyalty program information, etc. Consumer data may also include a consumer identifier that may be any identifier used by an advertiser to identify the consumer, such as a loyalty program identification number, a shopper number, a tracking cookie identifier, etc. Advertiser database 108 may also include advertiser data that is not inherently specific to a particular consumer or individual. For example, advertiser data may include information regarding an advertising campaign, data regarding one or more merchant locations, promotional data, data regarding particular goods and/or services, etc. In one embodiment, certain advertiser data may serve in conjunction with, or as the source for, some or all of the variable content data included in variable content database 106.

According to certain embodiments, analytics database 110 may include analytical data and/or user tracking gathered based upon an individual's interactions with Internet content. As detailed below, the analytical data may include information regarding readers' interactions with Internet content associated with an Internet content code included in personalized print content assembled by customization platform 102. Analytical data may be used for a number of purposes, such as tracking or reporting a reader's interactions with Internet content. For example, analytical data may indicate which content was initially accessed, what interactions an individual made with the content, the location at which the Internet content was accessed, subsequent interactions with the content, any purchases conducted after the content was accessed, which content was accessed after the initial content, etc.

In certain of these embodiments, PPCS 100 may determine whether the individual accessing the Internet content via an Internet content code is the intended reader (e.g., a particular subscriber) or another individual (e.g., another reader). For example, a reader data record include may include a device identifier that allows PPCS 100 to determine whether the Internet-enabled device being used to access the Internet content corresponds with the device identifier associated with the reader data record. As discussed below, in certain embodiments, the analytical or user tracking data may be used to customize or personalize various print content (e.g., advertisements, articles, cover pages, etc.) and/or Internet content associated with subsequent projects, such as later versions of a publication.

In certain embodiments, Internet content server 112 may be any appropriate combination of hardware, software, and/or computing components through which an individual, such as a reader, may access Internet content via Internet-enabled device 114. Internet content server 112 may be a web server, a mobile application server, or another similar mechanism that distributes and maintains Internet content. It may be managed by an advertiser, a publisher, a printing service provider, the customization service provider. In certain other embodiments, it may be maintained by a third-party, such as a web content service provider. In certain of these embodiments, Internet content server 112 may include an Internet content database maintaining data that allows Internet content to be communicated to one or more readers that are identified by the readers' Internet content codes, as described in further detail below. Internet-enabled device 114 may be a mobile phone (e.g., a cellular phone, a smartphone, etc.), an electronic music player (e.g., an iPod, an MP3 player), a personal data assistant (PDA), a tablet computer (e.g., iPad, Kindle Fire, Samsung Nexus, etc.), a personal computer (e.g., a laptop computer, a desktop computer, etc.), or any other suitable device that is capable of accessing and/or displaying data through the Internet.

In certain embodiments, when Internet-enabled device 114 accesses Internet content server 112, Internet content server 112 may receive or determine data regarding the location of Internet-enabled device 114. For example, the Internet-enabled device 114 may communicate various location data to Internet content server 112 in conjunction with requesting Internet content associated with an Internet content code. Location data may include, for example, Internet Protocol (IP) ranges, Global Position System (GPS) coordinates, Wi-Fi tracking information, or any other suitable location-based data. As described below, Internet content server 112 may use the location data to generate, select and/or assemble the Internet content to be communicated to the Internet-enabled device 114.

As shown in FIG. 1, PPCS 100 may interact with one or more publication systems configured to produce one or more forms of print media to enable the production of a personalized print page and/or to enable the inclusion of a personalized print page with the fixed content of a print publication. In one embodiment (not illustrated), PPCS 100 and a publication system may be components of one system. In certain other embodiments PPCS 100 may be connected to one or more separate publication systems or communicates through various networks. A publication system may include print service platform 118 and printer/binder mechanism 116 as illustrated in FIG. 1. Print service platform 118 may be configured to use personalized print content received from customization platform 102 and communicate data to printer/binder mechanism 116 for printing and/or binding of print content. In certain of these embodiments, a publication system may interpret a sequence code included with the personalized print content in order to determine how the content is to be formatted, printed, bound, etc. For example, a publication system may determine the page format, the location of the page in a publication, the order of the pages, etc.

A publication system may print and/or bind one or more pages based upon personalized print content into a publication along with the publication's fixed content. In certain of these embodiments, in addition to the personalized print content, customization platform 102 may provide the fixed content, or a portion thereof, to the publication system. In other embodiments, the fixed content is provided by another entity, such as a publisher.

For example, a publication system may include a digital printing press, such as the HP T300 Color Inkjet Web Press produced by Hewlett-Packard. A digital printing press may enable the production of large quantities of a publication that includes variable content (e.g., one or more personalized print pages) along with fixed content, and can produce such content at high speeds. Furthermore, a publication system may employ a binding apparatus and method such as the one disclosed in U.S. Pat. No. 7,874,550 to Warmus, the contents of which are incorporated by reference in their entirety as if recited in full herein. Warmus illustrates an example of a manner in which a personalized print page may be bound or otherwise included with fixed content in a publication. Each element of content to be included in a publication may be assigned a “version code” that identifies personalized content (e.g., a personalized print page) and non-personalized content (i.e., a fixed content page) to be included in a publication for a specific recipient. As printed pages are feed into feeding devices of the binding system, optical sensors may read an identification code (e.g., a barcode) included on the printed page to determine if and/or when a particular printed page is to be included in the publication being created.

Once the personalized print content has been published, it may be distributed to the readers through any appropriate channel. For example, periodicals may be mailed to subscribers.

### Personalized Print Content Creation

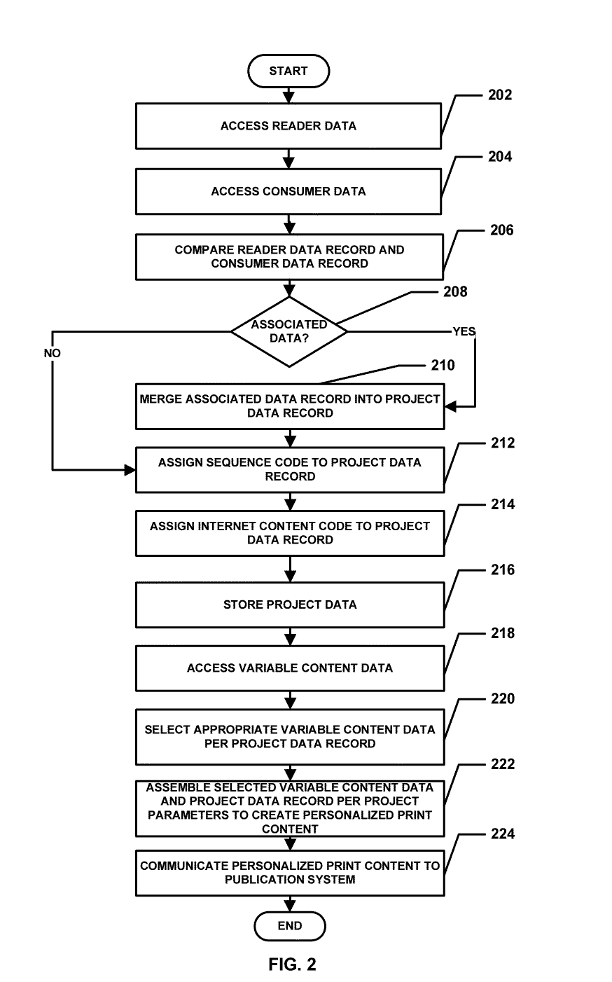

FIG. 2 depicts a flowchart of a process for creating print content that is personalized for a specific reader through customization platform 102 according to an exemplary embodiment. The print content customization process may be initiated per an instruction from the customization service provider, an advertiser, a publisher, a printing service provider, etc. In one embodiment, customization may be automatically initiated per a schedule.

As shown in FIG. 2, customization platform 102 may access reader data from reader database 104 (step 202) and may access consumer data from advertiser database 108 (step 204). Customization platform 102 may compare one or more reader data records and one or more consumer data records (step 206) to identify associations between the records of one dataset with the records of the other dataset (step 208). An association between a record in one dataset with a record in the other dataset may indicate that the two records pertain to the same individual. For example, a reader data record may include a name and address also found in a consumer data record. In one embodiment, customization platform 102 may accomplish the identification of corresponding data via a fuzzy-logic algorithm that recognizes similarity between data despite inconsistencies (e.g., differences in spelling or formatting, minor typographical differences, etc.).

In other embodiments customization platform 102 may utilize any other suitable form of algorithm or program for comparing the data records and identifying associations between the data contained in two or more records.

When an association between records is identified, customization platform 102 may merge the data from each record into a project data record for a specific reader (step 210). As the project data record may include more information than either the reader data record or the consumer data record, it may provide customization platform 102 with a more substantial perspective of the reader. For example, a reader data record may not include data regarding a reader's shopping patterns or a particular demographic data element (e.g., data regarding a reader's interests or income level), while a consumer data record may include such information. Conversely, a consumer data record may lack a complete or up-to-date mailing address for a specific reader, while the reader data record may include this information. By combining a reader data record and a consumer data record, customization platform 102 may create a more complete profile of a specific reader, and thereby allow for improved targeting or publication of content versus targeting based upon one data record alone.

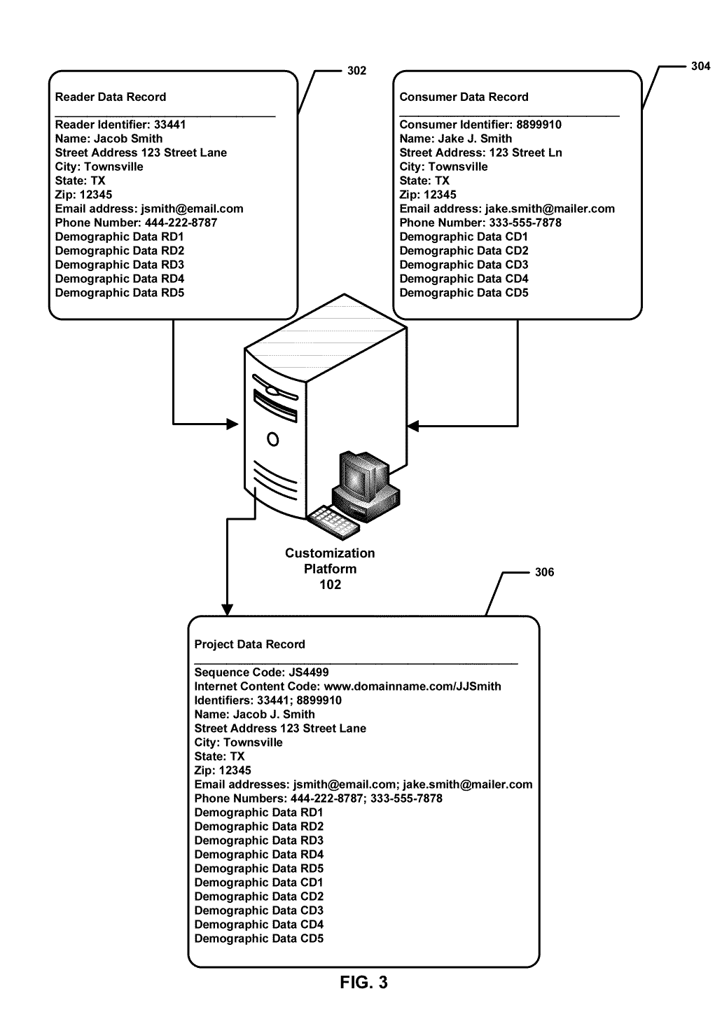

FIG. 3 depicts an illustrative overview of a manner in which reader data and consumer data may be combined into project data by customization platform 102 according to an exemplary embodiment. Reader data record 302 may include a reader identifier (e.g., a subscription number, an identification code, etc.), a name, address information, email address, phone number, and demographic data. Consumer data record 304 may include similar information, but with a consumer identifier rather than a reader identifier. Project data record 306 illustrates a project data record that includes data from both reader data record 302 and consumer data record 304.

If customization platform 102 does not identify an association between data records from both datasets for a specific individual, customization platform 102 may utilize the record it has (i.e., the reader data record or the consumer data record) as the project data record for that individual. In an alternate embodiment, customization platform 102 may compare data from sources other than, or in addition to, reader database 104 and advertiser database 108. Alternatively, customization platform 102 may only use reader data or consumer data as the project data.

As shown in FIG. 2, customization platform 102 may assign each project data record a sequence code (step 212). In certain embodiments, the sequence code is unique for each record in the project database. A sequence code may be used by one or more PPCS 100 components as a reference to a specific reader's data, to organize project data (e.g., sorting), to locate data, etc. As a sequence code may be used to identify a project data record, it may also be used to identify corresponding reader data and/or consumer data maintained by reader database 104 and/or advertiser database 108, respectively. In certain of these embodiments, the particular printed format of the sequence code may be determined by the requirements and/or capabilities of the publication system used to print the personalized print page.

Additionally, the sequence code may be used to indicate the manner in which the associated personalized print content is to be handled by a publication system. For example, a sequence code may designate whether the personalized print content is to be used to produce a cover page, an article, a portion of a page, a full page, an advertising insert, an advertising outsert, etc. As another example, a sequence code may indicate to a publication system the appropriate order for one or more pages of a print production and/or be used to detect and handle binding errors as described in more detail below. When printed, the sequence code may be included on the personalized print page in a machine-readable and/or human-readable format. For example, the sequence code may include a machine-readable barcode.

Customization platform 102 may assign an Internet content code to each project data record included in the project data (step 214) as shown in FIG. 2. In certain embodiments, the Internet content code is unique for each record in the project database. An Internet content code may be used to reference Internet content maintained by Internet content server 112. In one embodiment, an Internet content code may include a Uniform Resource Locator (URL) personalized to the specific reader. For example, a personal URL may be a web URL that includes a subdomain extension (e.g. ReaderName.domainname.com) or a domain subdirectory extension (e.g. www.domainname.com/ReaderName). As shown by the example in FIG. 3, the Internet content code for the reader “Jacob J. Smith” may include “www.domainname.com/JJSmith”. It is to be understood that an Internet content code may be any data that may be used by one or more Internet systems, devices, and processes to access particular Internet content.

When the personalized print content is printed, the Internet content code may be included in a machine-readable code on the personalized print page or portion thereof. This may allow a reader to readily access the associated Internet content. For example, the Internet content code may be included on a page, a barcode, a matrix code (e.g., a two-dimensional code such as a QR code), a URL, etc. In addition to referencing Internet content and/or a record associated with the reader, the Internet content code may include an identifier, name data, address information, demographic data, etc. that may be used and/or stored by Internet content server 112. In certain embodiments, the particular printed format and/or placement of the Internet content code may be determined per the stipulations of an advertiser, publisher, printing service provider, etc.

According to certain embodiments, such as shown in FIG. 2, the generated project data may be stored in a project database maintained by customization platform 102 (step 216). The project data may be employed whenever an advertiser and/or publisher wish to create personalized print content for the associated readers. In one embodiment, project data may be employed per an automated schedule. Furthermore, project data may be updated per an advertiser, publisher, printing service provider, or customization service provider instruction or per an automated schedule. In order to update a particular project dataset, customization platform 102 may be instructed to repeat the process described above (e.g., comparing databases, associating sequence and/or Internet content codes, etc.). It may completely repeat the process (e.g., repeat steps 202 through 214) or may update project data records as needed without, for instance, assigning new sequence codes and/or Internet content codes.

In one embodiment, project data may be stored only so long as it is needed to create personalized print content. For example, customization platform 102 may access reader data from reader database 104 and consumer data from advertiser database 108 and maintain the generated project data in memory only during the process of personalized print content creation. This may enable the creation of personalized print content that is based upon current data maintained by reader database 104 and/or advertiser database 108, such as to avoid using possibly out of date project data maintained by customization platform 102. In another embodiment, to ensure use of current data, generated project data may include links to source data rather than actual data elements. For example, generated project data may include links to data in a reader database 104 and/or advertiser database 108 maintained by one or more other parties, thereby ensuring that the project data is based upon the most current data.

Customization platform 102 may access variable content data (step 218) and may select a portion of appropriate variable content data per each project data record (step 220). In certain of these embodiments, once appropriate variable content data elements have been selected for a specific reader, customization platform 102 may assemble these elements based on one or more project record data elements per one or more parameters established for the particular project, thereby creating print content personalized for the specific reader (step 222). For example, a reader's name may be employed with verbal messages and images to create a personalized print page.

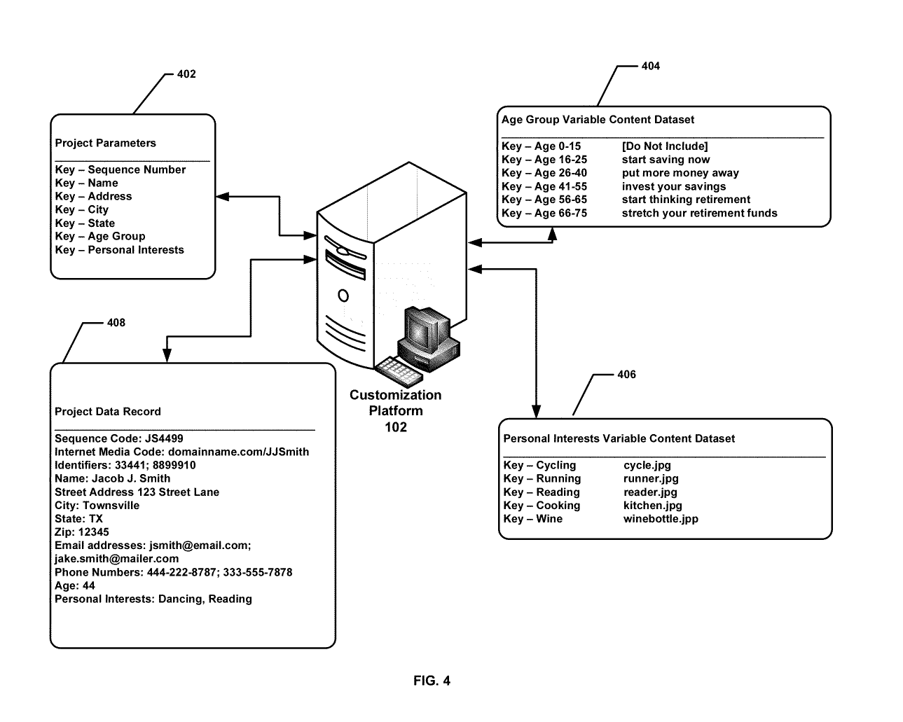

FIG. 4 depicts an illustrative overview of a manner in which one or more project parameters may be employed to determine the selection and/or arrangement of variable content data elements to be included in personalized print content for a number of readers according to an exemplary embodiment. Project parameters 402 include a listing of keys that may be used to determine appropriate variable content for a reader. For example, among other keys, project parameters 402 may indicate that a reader's age group and personal interests are to serve as a key for one or more variable content data elements. As shown in FIG. 4, when determining which element of Age Group Variable Content Dataset 404 and which element of Personal Interests Variable Content Dataset 406 to select for the reader based on project data record 408, customization platform 102 may reference the reader's age and personal interest demographic data to determine the appropriate elements. For example, the demographic data included in project data record 408 indicates that the reader is 44 years old and that “Reading” is a personal interest, thus, customization platform 102 may select “Invest Your Savings” and “reading.jpg”, respectively, as appropriate variable data elements for the personalized print content associated with the reader.

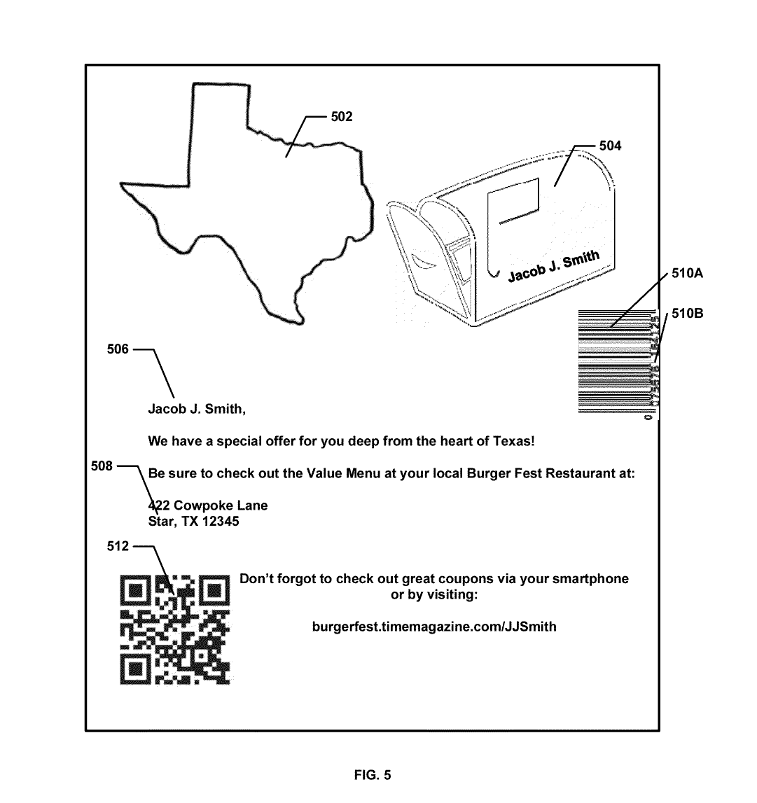

As shown in FIG. 4, customization platform 102 may communicate the personalized print content to a publication system (step 224) for printing of the content and/or binding of the printed content with the other content (e.g., fixed content) of the publication. FIG. 5 depicts an illustrative example of a printed page having content personalized for a specific reader that may be created via customization platform 102 according to an exemplary embodiment. The example page includes regional image 502 based upon the reader's address, the reader's name on image 504, personalized message 506, merchant location 508 based upon the reader's address, a sequence code included in machine-readable code 510A and human-readable code 510B, and an Internet content code included in machine-readable code 512. The printed sequence code may be located anywhere in the personalized print page that would enable its use by a publication system, an operator, a distribution system, etc. In one embodiment, the sequence code and Internet content code may be included in the same machine-readable code. For example, a matrix code (e.g., the QR code) may include both the sequence code and the Internet content code.

In certain embodiments, the sequence code may be used to ensure that the personalized print content is printed, bound, inserted, etc. appropriately by the publication system. The sequence code may be used by a publication system to coordinate the binding and addressing process for an individual publication (e.g., a magazine). For example, the apparatus and method of the aforementioned, U.S. Pat. No. 7,874,550 to Warmus may employ the sequence code as a version code in order to determine the appropriate personalized and non-personalized printed pages to include in a publication for one or more readers. The format in which the sequence code is included on the printed page may be determined based on the specific equipment used by the publication system service provider. As mentioned, the sequence code may be included on the printed page in a machine-readable format, a human-readable format, or a combination thereof. The sequence code may be included in both machine-readable and human-readable formats in order to permit an operator to identify a printed page without the use of an electronic device (e.g., a portable barcode scanner). The printed format of the sequence code, including its positioning, may vary based upon the purpose of the personalized print page. It may be positioned anywhere on the page that may enable or enhance its use and/or to avoid interference with the main printed content. For example, the printed format may vary based upon whether the personalized print page is to be packaged as an insert (e.g., bound inside a magazine) or as an outsert (e.g., bound/collated outside a magazine).

In the example illustrated by FIG. 5, the machine-readable sequence code is included as a one-dimensional barcode placed along the edge of the printed page. In another exemplary embodiment (not illustrated), the machine-readable code may be included in a matrix code. In yet another exemplary embodiment, the sequence code may be included in a visual image other than a one-dimensional barcode or matrix code. For example, a publication system may have integrated image recognition capabilities and may be able to read various image types.

### Personalized Print Content Publication

The personalized print content may be encoded as necessary for the particular publication system. As aforementioned, the publication system may be managed by the customization service provider or it may be an external service. In one embodiment, the publication system may include a digital printing press.

The production process used to print the personalized print page may sequentially produce pages in a specific order, such as defined by a publication's distribution process. The production process may include the production of a publication's individual elements in a predetermined sort order in order to match a planned binding process of the final publication. This may be done in order to accommodate a physical binding and/or distribution process that may involve the selective insertion of multiple content sections, as well as to sort the final publication in a specific order (e.g., for applying postage). The production process may include procedures that facilitate the packing of cartons to be used on the final publication's binding line.

In one exemplary embodiment, such as when large quantities of the publication are to be produced, customization platform 102 may be configured to instruct the publication system to include one or more separator sheets in specific positions within the printed materials. A separator sheet may include sufficient information to enable a publication system or operator to ascertain what materials are to be included, and may also serve as a quality control medium to ensure that an operator places the personalized print pages into the binding equipment in the correct sequence. A separator sheet may include, for example, a project name, a job or work order number, a publication name, publication issue data (e.g., volume and/or issue number), a reference name for variable content (e.g., the advertisement or advertising campaign), a carton number (e.g., for a binding carton), a start sequence code, an end sequence code, a total quantity number, etc. The frequency at which a separator sheet is produced may be based on, for example, the specific paper stock used, the size of the binding cartons to be employed, how many individual personalized print pages are to be placed into a single carton, etc.

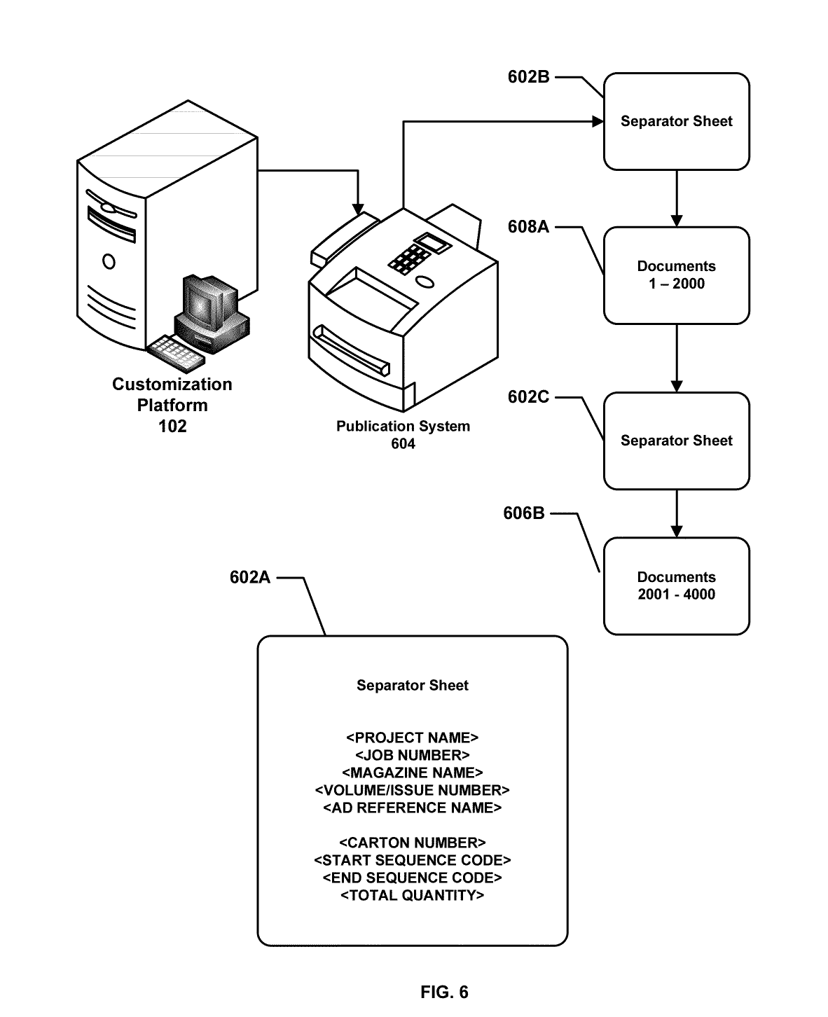

FIG. 6 depicts an illustrative overview of a manner in which separator sheets may be created via customization platform 102 and included during a variable printing process according to an exemplary embodiment. Separator sheet 602A illustrates an example of the information that a separator sheet may include. In this example, the publication is a magazine, and therefore the separator sheet includes the magazine's name and the volume and issue number, as well as other typical information. As the personalized print page in this example is an advertisement, it includes an ad reference name as well. In the example depicted, a separator sheet (i.e., 602B and 602C) is included between every 2000 documents produced (i.e., 606A and 606B) by publication system 604.

### Internet Content Access Via a Personalized Print Page

As mentioned above, a personalized print page may include an Internet content code specific to a reader. An Internet content code may be entered into an Internet-enabled device 114 in an automated or manual fashion. As mentioned, an Internet-enabled device 114 may be any device configured to access and communicate data via the Internet. An Internet content code may be included in a personalized print page in a machine-readable code, such as a one-dimensional barcode, as a matrix code (e.g., the type of two-dimensional bar code known as a QR code), text (e.g., a printed URL), image, or any other format that may be useable by an Internet-enabled device 114. The Internet content code may be read from the machine-readable code via a device's barcode scanner or camera, entered via a keyboard or touchscreen, etc. and may function as a trigger that enables access to Internet content. For example, the Internet content code may be included in a QR code that allows a reader to select the code and trigger the retrieval of the Internet content by pointing a camera on the reader's Internet-enabled device at the code on the printed page. There are a number of well-known and other machine-readable code applications available for various types of Internet enabled devices that allow such QR codes to be captured using the devices' camera or scanner.

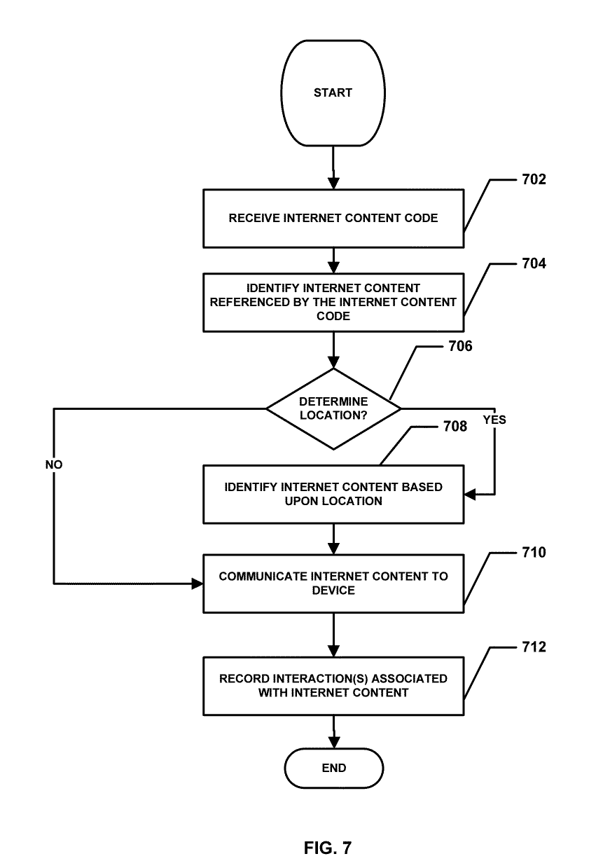

FIG. 7 depicts a flowchart of a process for delivering Internet content to an Internet-enabled device based upon an Internet content code included in a personalized print page created via customization platform 102 according to an exemplary embodiment. Once an Internet-enabled device 114 obtains an Internet content code (e.g., by electronically reading it from the personalized print page), the Internet media code may be communicated to and received by Internet content server 112 (step 702).

Internet content server 112 may use the Internet content code to identify Internet content stored in its database (step 704). For example, the Internet content code may include a URL and Internet content server 112 may retrieve appropriate webpage data. As the Internet content code may relate to or be unique to the reader, the content it identifies may be specific to the individual reader. For example, Internet content may be customized based upon a reader's demographic data. In one scenario, Internet content server 112 may be enabled to construct a webpage or configure actionable links dynamically based upon stored reader information. The reader information may be maintained by Internet content server 112 or may be accessed from reader database 104, advertiser database 108, and/or customization platform 102. In certain of these embodiments, the reader's information and/or demographic data, or a portion of it, may be included in the machine-readable code including the Internet content code, and communicated to Internet content server 112 from the Internet-enabled device 114. In certain embodiments, the Internet content referenced by the Internet content code may not be inherently targeted to a specific reader, but may be targeted for a group of readers (e.g., a particular demographic), or may be general content.

In certain of these embodiments, such as where the Internet content code is associated with a personalized print advertisement, the Internet content may include an offer targeted to the reader. An offer may include any promotional matter that may entice the reader to interact with an advertiser. For example, an offer may include a coupon (or a coupon code), promotional information (e.g., a sale), content information, etc. An offer may be targeted to the reader based on one or more of a reader's demographics, shopping history data, loyalty program data, or other data. In certain other embodiments, the Internet content may include content pertaining or related to the portion of the publication associated with the Internet content code, such as additional information about an article, image, story, etc.

In one embodiment, Internet content server 112 may customize the Internet content provided to the reader based upon the reader's location (e.g., the current location of the Internet-enabled device 114). Internet content server 112 may attempt to determine a reader's location based upon data obtained from the Internet-enabled device 114 (e.g., GPS coordinates, Wi-Fi tracking data, etc.) (step 706). For example, an Internet-enabled device 114 may communicate location data to Internet content server 112 in conjunction with an Internet content code. If Internet content server 112 is able to determine the location of the Internet-enabled device 114, it may identify, assemble, and/or customize Internet content based upon the location (step 708).

The Internet content may vary depending upon whether Internet content server 112 is able to determine the reader's current location. If a location was not determined based upon received data, Internet content server 112 may customize the Internet content based on previously stored location data, such as the reader's mailing address. For example, the Internet content may include an offer for a coffee shop near the reader's home address. If Internet content server 112 was able to determine the reader's current location, the Internet content may include data relevant to the reader's current location. For example, if the reader is located somewhere other than his home (e.g., a service station, an airport, etc.) the Internet content may include an offer for a coffee shop near the reader's current location (e.g., the service station, the airport, etc.).

In one embodiment, location-based content may be based solely on stored content rather than data obtained via an Internet-enabled device 114. For example, Internet content server 112 may maintain one or more Internet content records associated with an Internet content code (and, in turn, a reader) and may communicate the content deemed most relevant to the reader's location. In another embodiment, as described below, the Internet content communicated to the Internet-enabled device 114 may be based solely on the obtained location data and not otherwise include any inherently reader-specific data.

In certain embodiments, the selection of location-based content may be based on other factors as well. For example, a particular advertiser may wish to drive traffic to a particular merchant location and, the Internet content data provided may pertain to that merchant location if it is relatively close (e.g., even if another merchant location is closer). In certain other embodiments, such as where a location cannot be determined via received or stored location data, the Internet content presented may not be customized per a specific location. As shown in FIG. 7, after determining the appropriate Internet content, Internet content server 112 may communicate the Internet content to the Internet-enabled device 114 (step 710).

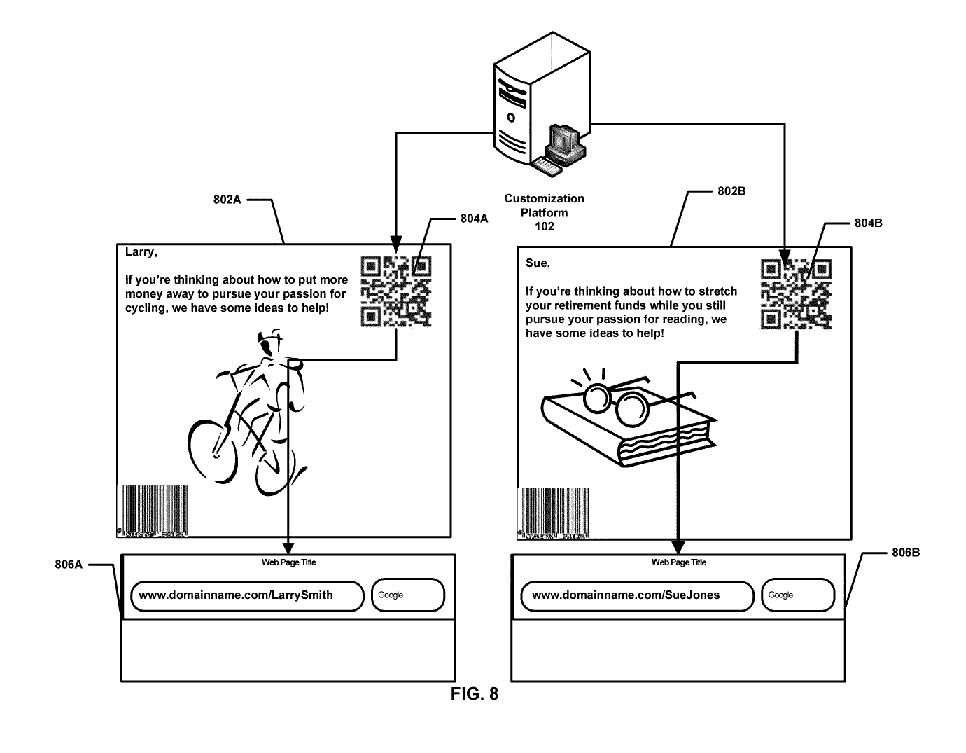

FIG. 8 depicts an illustrative overview of two personalized print pages created via customization platform 102, both of which include Internet content codes that are specific to individual readers according to an exemplary embodiment. Customization platform 102 may assign each reader a unique Internet content code. In the illustrated example, Larry Smith's unique Internet content code includes the URL “www.domainname.com/LarrySmith” and Sue Jones' unique Internet content code includes the URL “www.domainname.com/SueJones.” Internet content codes may be included in personalized print pages 802A and 802B in machine-readable codes 804A and 804B, respectively, which may be in the form of QR codes, as shown in FIG. 8. When the machine-readable codes are read by an Internet-enabled device, the captured Internet content codes may enable access to Internet content personalized to each specific reader, such as Internet content 806A for Larry Smith and Internet content 806B for Sue Jones.

In certain of these embodiments, Internet content server 112 may record a reader's interactions with the Internet content and store this analytical data in analytics database 110 (step 712). A reader's interactions with the Internet content may be tracked and recorded via any known method, such as through use of various tracking cookies. The analytical data may include data regarding the user's location during an interaction, the time of an interaction, the length of an interaction, the medium used (e.g., which web browser or app, which device, etc.), the operating system employed, form data entered, which hyperlinks were selected, how many hyperlinks were selected, the number of times the Internet content was accessed, etc. In certain of these embodiments, the analytical data may include information associated with tracking the reader's actions after viewing the Internet content, such as whether the reader navigated to other websites having content related to the Internet content and/or whether the reader selected a link to purchase a good or service associated with the Internet content.

In certain embodiments, such as where as Internet content server 112 enables the distribution of location-relevant content to a reader, location-related data may be stored and tracked. As the personalized print page may be included in various types of publications such as magazines and an Internet content code may be accessed by a range of Internet enabled devices associated with a number of readers. Internet content server 112 may record certain data pertaining to each access of the Internet content code, such as to determine the location of the publication and/or the device being used to access the Internet content. In effect, recording data each time an Internet content code is used to access Internet content may enable tracking of the location of the publication and its reader.

As aforementioned, a device identifier may be included in one or more of the reader's records. When an Internet-enabled device 114 accesses Internet content via an Internet content code, Internet content server 112 may receive a device identifier from the Internet-enabled device 114. The received device identifier may be compared with a device identifier included in one or more records associated with the Internet content code to determine whether the accessing Internet-enabled device 114 is the reader's device. If so, Internet content server 112 may record that the targeted reader (or at least his device) employed the Internet content code. If the received device identifier is different than the one in the record, Internet content server 112 may log that another party (or at least another device) was used to access Internet content via the Internet content code. The new device identifier may be stored and, in certain embodiments, further interactions conducted via the associated Internet-enabled device may be tracked and recorded. In certain of these embodiments, if the received device identifier is not associated with a record indicated by the Internet content code, it may be compared to other records in order to determine if the accessing Internet-enabled device is associated with another known individual.

The analytical data may be used for reporting functions by an advertiser, customization system provider, publisher, printing service provider, and/or a third party. As an Internet content code may reference a particular reader, it may be used to determine data about the reader (e.g., to access demographic data included in project data, reader data, and/or consumer data), to analyze the interactions he made (if any) with the Internet content, etc. In one embodiment, the analytical data may be subject to analysis based on predefined algorithms that measure the return on investment for an advertiser and/or a custom analysis as requested by an advertiser.

In certain embodiments, the analytical data may be used for marketing purposes, such as to attract additional advertisers for the publications. For example, the analytical data may be used to show that a number of the readers of the publication are interested in a particular type of good or service. Similarly, analytical data may be used to show that readers are interested in certain articles, stores, pages, or other types of content included in the publication.

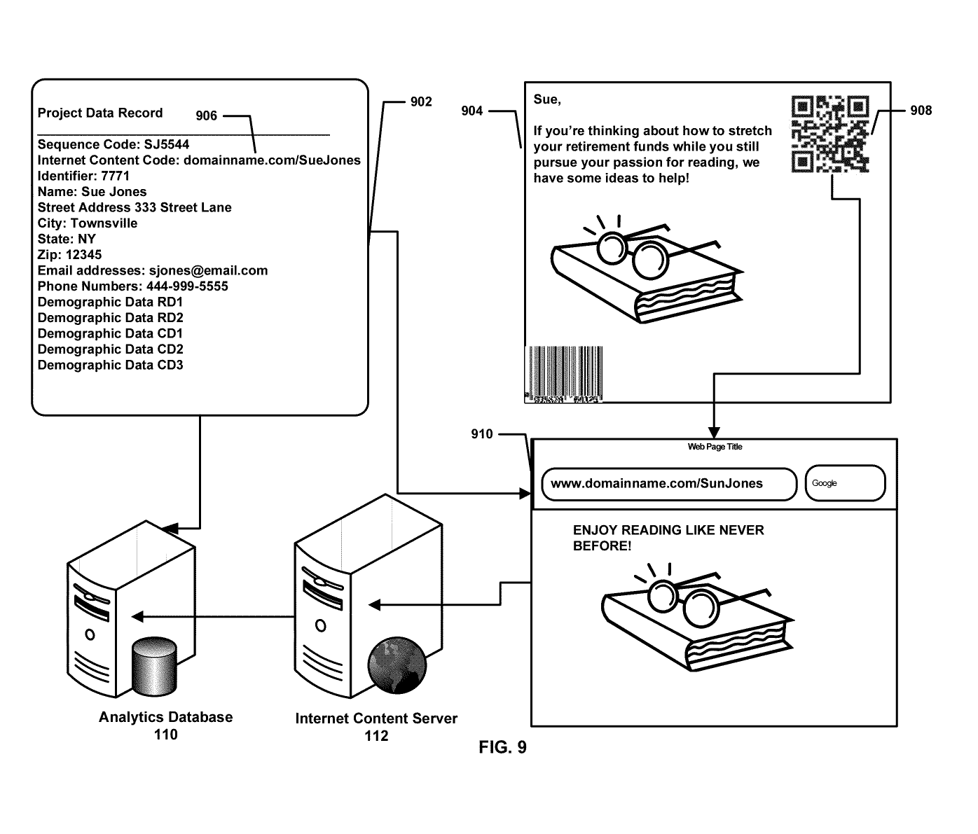

FIG. 9 depicts an illustrative overview of gathering analytical data based upon a reader's interactions with Internet content accessed via an Internet content code included in a personalized print page created via customization platform 102 according to an exemplary embodiment. Project data record 902 includes Internet content code 906 (in this case, “www.domainname.com/SueJones”), which is included in machine-readable code 908 included on personalized print page 904. When the machine-readable code 908 is accessed by an Internet-enabled device 114, the reader may view personalized Internet content 910. Personalized Internet content 910 may be based one or more elements of data included in project data record 902. In turn, Internet content server 112 may enable the recordation of reader interactions with personalized Internet content 910, and other Internet content, in analytics database 110. This analytical data may be associated with one or more elements of the reader's project data in order to refine the analytical data and enable reporting. To various parties (e.g., advertisers, publishers, etc.).

Due to the tracking of a reader's interactions with Internet content accessed via personalized print content (and, thus, a reader's interaction with the personalized print content), PPCS 100 may enable exceptional reporting functionality. For example, an advertiser may analyze click patterns to calculate a presumed return on investment. Interaction tracking, analysis, and calculation may be based on one more on variable inputs, such as total cost, cost per click, and estimated conversion rate. PPCS 100 may allow one to cross-match reader data with advertiser data in light of analytical data, thereby enabling the ability to build unique analytics profiles of individuals by specific demographics characteristics (shopping history, ethnicity, etc.) and to evaluate content effectiveness based on initial or subsequent interactions. Moreover, this capability enables the measurement of the effectiveness of the targeted content, particularly with respect to subscriber-based printed publications, and allows therefore for better targeting and customization of advertisements to specific readers.

Additionally the tracking and analysis of analytical data of readers employing Internet content codes may be used to refine and enhance the targeting and creation of personalized print content, thereby enabling a complete personalization process from the initial targeting of content, to the generation of personalized print content, the publishing and distribution of the personalized print content, and the tracking of reader interactions with Internet content accessed via a personalized print page. For example, customization platform 102 may generate personalized print content for an advertisement targeted for Larry Smith that includes content reflective of his demographic data, such as, that he is male, 65 years old, and interested in biking. When Larry Smith peruses the publication including the personalized advertisement, he may use his smartphone to scan a machine-readable code included in the advertisement, thereby relaying the included Internet content code to Internet content server 112. After viewing the initial Internet content (e.g., an offer for a bicycling vacation for retirees), he may purchase an item offered in the Internet content (e.g., the bicycling vacation package), and may navigate to another website. Internet content server 112 may record this interaction, including noting that the other website he navigated to was for a car dealership. After generating a report based upon this analytical data, an advertiser employee or an automated process may revise Larry Smith's consumer data record to indicate an interest in automobiles or a car purchase. This new data may then be used in when customizing further personalized print content for Larry Smith, such that the next personalized advertisement he receives includes content that pertains to automobiles.

As another example, the analytical user-tracking data may be used by a publisher to customize and/or personalize the substantive content of a publication, such as the cover page of the publication, the articles included within the publication and/or any other form of non-advertising related content. The images, text, etc. used on a cover page of a magazine for a particular reader may be based on the reader's interests (e.g., including an image of a particular type of car or the cover an automobile magazine). Likewise, one or more of the articles included in the magazine may be selected or customized based on the reader's interests. In certain of these embodiments, the personalized content may also, or alternatively, be based on preferences indicated by the reader (e.g., an indication from the reader of an interest in particular topic area).

As shown by the foregoing discussion, PPCS 100 and the accompanying systems and materials described herein provide significant improvements in the advertising of publishers, advertisers and other parties to customize and/or personalize a wide range of print content, such as advertisements, articles, and virtually any type of content included with or within printed publications. The described systems and methods also enable various electronic content, such as Internet content, to be linked to the customized or personalized print content, thereby allowing readers to access additional content directly from the personalized or customized print content. By doing so, data associated with the reader can be traced and/or analyzed, such as to determine various demographics, interests, activities, etc. for the readers. Importantly, this allows for the subsequent generation of print and/or electronic content that is further customized and/or provided for the reader, thereby increasing the relevance, effectiveness, or value of the content to the reader, as well as after printing (e.g., advertisers, publishers, etc.).

### ADDITIONAL APPLICATIONS

Although customization platform 102 may enable the customization of content for magazines, newspapers, books, or other publications, it may similarly be employed to include an Internet content code on any print media. In certain embodiments, an Internet content code may serve as a way to enable access to sensitive information without including that information in a document itself. For example, a medical or financial document may include an Internet content code in order to direct a reader to a secure site that allows access to medical or financial records. In order to enhance security, access to sensitive content may restricted by a device identifier. When an Internet-enabled device 114 attempts to access the sensitive content via the Internet content code, Internet content server 112 may compare the requesting device's device identifier with one included the record associated with the Internet content code in order determine whether the access request originated from the appropriate Internet-enabled device 114. If so, the reader may access the sensitive content. If Internet content server 112 does not recognize the device used, the reader may be directed to a more general site. Alternatively, or additionally, sensitive content may be restricted via traditional methods (e.g., a username and password).

Through the use of Internet content codes, customization platform 102 may be employed to create location-aware publications. This may be particularly useful for postings (e.g., posters, signs, etc.), flyers, bulletins, and other similar documents. As a publication's Internet content code may enable the delivery of content relevant to the location at which it is read or entered, the publication may serve as a convenient medium by which a reader can obtain information associated with his surroundings. Customization platform 102 may be used to create a publication designed to provide regional information, such as tourist information, public transportation information, etc. For example, a reader may scan an Internet content code in order to obtain a train schedule for a nearby train stations. Although the Internet content codes for such publications may not be inherently reader-specific, they may be reader-specific in regard to the reader's environment and/or a reader may be identified via a device identifier.

While there have shown and described and pointed out various novel features of the invention as applied to particular embodiments thereof, it will be understood that various omissions and substitutions and changes in the form and details of the systems and methods described and illustrated, may be made by those skilled in the art without departing from the spirit of the invention. Those skilled in the art will recognize, based on the above disclosure and an understanding therefrom of the teachings of the invention, that the particular hardware and devices that are part of PPCS 100, and the general functionality provided by and incorporated therein, may vary in different embodiments of the invention. Accordingly, the particular system components shown in FIGS. 1-9 are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation, and the present invention is limited only by the claims which follow.

What is claimed is:

1. A system for creating personalized content for a print publication, the system comprising:
a computing device having physical memory that stores:
reader data associated with a reader of a print publication;
advertiser data associated with an advertising campaign, the advertiser data including consumer data associated with a consumer to be targeted through the advertising campaign;
Internet content data associated with the advertising campaign, the Internet content data enabling the generation of customized Internet content for the reader; and
variable content data associated with the advertising campaign, the variable content data enabling the generation of variable content to be included with the print publication; and
the computing device further comprising a processor coupled to the physical memory, the processor adapted to:
determine project record data by merging the consumer data with the reader data;
select a portion of the variable content data for the reader based, at least in part, on the project record data;
generate an Internet content code specific to the reader, the Internet content code allowing access to the customized Internet content through an Internet-enabled device;
generate personalized content data specific to the reader, the personalized content data including the selected portion of the variable content data and the generated Internet content code; and
provide the personalized content data to a variable printing device for printing a reader-specific variable portion based on the personalized content data that is combined with a fixed portion of the print publication to be delivered to the reader.

2. The system of claim 1, wherein one or more of the reader data, the advertiser data, the Internet content data, and the variable content data are stored in at least one database on the physical memory of the computing device.

3. The system of claim 2, wherein the at least one database is stored at a database server accessed by the computing device over a network.

4. The system of claim 1, wherein the reader comprises a plurality of readers and the personalized content data generated for each of the plurality of readers further includes a reader-specific sequence code that enables the variable printing device to determine the manner in which to combine the reader-specific variable portion associated with each of the plurality of readers with the fixed portion of the print publication.

5. The system of claim 4, wherein the reader-specific sequence code further enables the variable printing device to determine whether an error has occurred in combining the reader-specific variable portions with the fixed portion of the print publication.

6. The system of claim 4, wherein the reader-specific sequence code comprises one or more of a machine-readable code and a human-readable code.

7. The system of claim 1, wherein the Internet content code comprises a code selected from the group consisting of a barcode, a three-dimensional barcode, a matrix code, and a Uniform Resource Locator.

8. The system of claim 1, wherein the customized Internet content includes one or more of Internet content pertaining to the reader and Internet content pertaining to the location of the Internet-enabled device.

9. The system of claim 1, further comprising a web server computer adapted to:
receive, in response to a user selecting the Internet content code, a request from the user to access the customized Internet content;
generate the customized Internet content; and
transmit the customized Internet content to the user.

10. The system of claim 9, wherein the user is the reader.

11. The system of claim 9, wherein the web server computer is further adapted to determine a location associated with the user based on the request, and wherein the customized Internet content includes location-specific data based on the determined location.

12. The system of claim 11, wherein the location-specific data includes a store location associated with the advertiser.

13. The system of claim 9, wherein the web server computer is further adapted to store tracking data associated with one or more interactions by the user with the customized Internet content.

14. The system of claim 13, wherein the tracking data is stored in an analytics database associated with the web server computer.

15. The system of claim 13, wherein the processor of the computing device is further adapted to select the portion of the variable content data for the reader based, at least in part, on the tracking data.

16. The system of claim 1, wherein the reader data includes one or more reader demographic items selected from the group consisting of an identifier, a name, and age, a sex, a mailing address, a phone number, and an email address.

17. The system of claim 1, wherein the consumer data includes one or more consumer demographic items selected from the group consisting of an identifier, a name, a mailing address, a phone number, an email address, shopping history information, and loyalty program information.

18. The system of claim 1, wherein the advertiser data further includes one or more advertiser demographic items selected from the group consisting of a store location, a promotion, a good, a service, and a loyalty program.

19. A method of creating personalized content for a print publication, the method comprising:
accessing, by a computer, reader data, the reader data including data associated with a plurality of readers of a print publication;
accessing, by the computer, user demographic data, the user demographic data including data associated with one or more of the plurality of readers;
determining, by the computer, project record data based, at least in part, on merging the reader data with the user demographic data;
accessing, by the computer, variable content data including data associated with an advertising campaign;
selecting, by the computer, a portion of variable content data for each of the plurality of subscribers based, at least in part, on the project data;
generating, by the computer, an Internet content code specific to each of the plurality of readers, the Internet content code allowing access to customized Internet content associated with the advertising campaign through an Internet-enabled device;
creating, by the computer, personalized content data specific to each of the plurality of readers, the personalized content data for each reader including the selected portion of variable content data and the generated Internet content code;
providing, by the computer, the personalized content data to a variable printing device for printing a reader-specific variable portion based on the personalized content data that is combined with a fixed portion of the print publication to be delivered to the reader.

20. The method of claim 19, wherein the print publication is a periodical, a book, a pamphlet, an insert, an outsert, a posting, a bulletin, or a flyer.

21. The method of claim 19, wherein the Internet-enabled device is a mobile phone, an electronic music player, a personal digital assistant, a tablet computer, or a personal computer.

22. The method of claim 19, wherein the customized Internet content includes one or more of Internet content pertaining to the reader and Internet content pertaining to the location of the Internet-enabled device.

23. The method of claim 19, the method further comprising storing tracking data associated with one or more interactions by a user with the customized Internet content.

24. A method for providing Internet content to an Internet-enabled device based upon a machine-readable code included in a print publication, the method comprising:
receiving, at a computer from an Internet-enabled device, an identification reference obtained by the Internet-enabled device from a machine-readable code included in a print publication, wherein the machine-readable code was included in print content personalized for a reader of the print publication;
identifying, at the computer, Internet t content associated with the identification reference; and
communicating, by the computer to the Internet-enabled device, the identified Internet content data, thereby enabling the Internet-enabled device to present Internet content associated with the print content personalized for the reader.

25. The method of claim 24, wherein the print content personalized for the reader is personalized based upon an association between data associated with the reader and variable content data.

26. The method of claim 24, wherein the machine-readable code comprises a code selected from the group consisting of a barcode, a three-dimensional barcode, a matrix code, and a Uniform Resource Locator.

27. The method of claim 24, wherein the Internet-enabled device is selected from the group consisting of a mobile phone, an electronic music player, a personal digital assistant, a tablet computer, and a personal computer.

28. The method of claim 24, wherein the method further comprises determining location data associated with the Internet-enabled device and adjusting the Internet content per the determined location data.

29. The method of claim 24, wherein the Internet content includes content that has been personalized to the reader.

30. The method of claim 30, wherein the Internet content is personalized based upon identified an association between data associated with the reader and variable content data.

31. A system for creating personalized content for high-volume print publications delivered regularly to a plurality of readers, the system comprising:
a computing device having physical memory storing instructions that cause the computing device to:
determine project record data based, at least in part, on merging reader data retrieved from a first storage location, the reader data including data associated with a plurality of readers of a print publication, and user demographic data retrieved from a second storage location, the user demographic data including data associated with one or more of the plurality of readers;
select a portion of variable content data for each of the plurality of subscribers based, at least in part, on the project data;
generate an Internet content code specific to each of the plurality of readers, the Internet content code allowing access to customized Internet content associated with the selected variable content data through an Internet-enabled device;
generate personalized content data specific to each of the plurality of readers, the personalized content data for each reader including the selected portion of variable content data and the generated Internet content code; and
provide the personalized content data to a variable printing device for printing a reader-specific variable portion based on the personalized content data that is combined with a fixed portion of the print publication to be delivered to the reader.
